(19) United States
(12) Patent Application Publication
(10) Pub. No.: US 2024/0195700 A1
(43) Pub. Date: Jun. 13, 2024

(54) METHODS AND APPARATUSES FOR REPORTING ANOMALIES AND FORECASTING KEY PERFORMANCE INDICATOR (KPI) MEASUREMENTS IN A TELECOMMUNICATIONS NODE

(71) Applicants: Saman BASHBAGHI, Candiac (CA); Jean Michel SELLIER, Montreal (CA); Mostefa GOLEA, Ottawa (CA); Sathi MARATH, Kanata (CA); TELEFONAKTIEBOLAGEN LM ERICSSON (PUBL), Sweden (SE)

(72) Inventors: Saman Bashbaghi, Candiac (CA); Jean-Michel Sellier, Montreal (CA); Mostefa Golea, Ottawa (CA); Sathi Marath, Kanata (CA)

(73) Assignee: TELEFONAKTIEBOLAGET LM ERICSSON (PUBL), Stockholm (SE)

(21) Appl. No.: 18/281,454

(22) PCT Filed: Mar. 12, 2021
(86) PCT No.: PCT/IB2021/052095

§ 371 Date: Sep. 11, 2023

(51) Int. Cl. H04L 41/142; H04L 41/147

(52) U.S. Cl. CPC H04L 41/142; H04L 41/147

(57) ABSTRACT

The disclosure relates to a method, for reporting an anomaly in a telecommunications node. The method comprises obtaining a measurement of a key performance indicator (KPI) of the telecommunication node. The method comprises, upon receiving the measurement of the KPI, updating coefficients of a polynomial function. The method comprises, based on the updated coefficients of the polynomial function, computing an expected measurement of the KPI coefficient. The method comprises computing a confidence band for the expected measurement of the KPI. The method comprises reporting the anomaly when the measurement of the KPI is outside of the confidence band. The disclosure also relates to a method for forecasting a plurality of expected measurements for a key performance indicator (KPI) in a telecommunications node, as well as to apparatuses for executing these methods.

### TECHNICAL FIELD

The present disclosure relates to surveillance of key performance indicators in telecommunications nodes.

### BACKGROUND

We are now living in the big data and real-time processing era. In telecommunications networks management domains, large number of metrics, key performance indicators (KPIs), are continuously monitored, on almost every network device. The resulting data streams are then pipelined and analyzed, in near real-time, for anomalies, trends, correlations, etc. Network operators combine those real-time analytics to react and correct issues, to keep the networks running smoothly. Machine Learning (ML) and Artificial Intelligence (AI) are becoming key components of network management solutions.

In the time series analysis community, there has been a long-standing consensus that sophisticated methods do not necessarily produce better forecast and/or anomaly detection (AD), when compared to simpler methods. This was one of the conclusions of the influential M3 forecasting competition held in 1999. Simpler and noise-insensitive models, with reasonable assumptions about the data, will typically perform very well, e.g. Exponential Smoothing techniques and the well-known AutoRegressive Integrated Moving Average (ARIMA) method.

Anomaly-detection in time-series is a well-established field of research. A large number of models and techniques are documented in the literature. Anomaly-detection has applications in many domains, including telecommunications networks management, fraud detection, health, etc.

### SUMMARY

Existing models do not fully address the complexities of deploying and maintaining a productized anomaly-detection solution, including complexities such as memory footprint, processing speed, and handling of data-drift.

In order to alleviate these difficulties, there is provided a method for reporting an anomaly in a telecommunications node. The method comprises obtaining a measurement of a key performance indicator (KPI) of the telecommunication node. The method comprises, upon receiving the measurement of the KPI, updating coefficients of a polynomial function. The method comprises, based on the updated coefficients of the polynomial function, computing an expected measurement of the KPI coefficient; computing a confidence band for the expected measurement of the KPI. The method comprises reporting the anomaly when the measurement of the KPI is outside of the confidence band.

There is also provided a method for forecasting a plurality of expected measurements for a key performance indicator (KPI) in a telecommunications node. The method comprises obtaining a measurement of the KPI of the telecommunication node. The method comprises, upon receiving the measurement of the KPI, updating coefficients of a polynomial function. The method comprises, based on the updated coefficients of the polynomial function, computing the plurality of expected measurements for the KPI, over a time-horizon. The method comprises computing a confidence band for each of the plurality of expected measurements for the KPI, using accuracy measurements obtained from past predictions. The method comprises reporting the plurality of expected measurements and corresponding confidence bands for the KPI to a management system.

There is provided an apparatus operative to report an anomaly in a telecommunications node. The apparatus comprises processing circuits and a memory, the memory containing instructions executable by the processing circuits whereby the apparatus is operative to obtain a measurement of a key performance indicator (KPI) of the telecommunication node. The apparatus is operative to, upon receiving the measurement of the KPI, update coefficients of a polynomial function. The apparatus is operative to, based on the updated coefficients of the polynomial function, compute an expected measurement of the KPI coefficient. The apparatus is operative to compute a confidence band for the expected measurement of the KPI. The apparatus is operative to report the anomaly when the measurement of the KPI is outside of the confidence band.

There is provided an apparatus operative to forecast a plurality of expected measurements for a key performance indicator (KPI) in a telecommunications node, The apparatus comprises processing circuits and a memory, the memory containing instructions executable by the processing circuits whereby the apparatus is operative to obtain a measurement of the KPI of the telecommunication node. The apparatus is operative to, upon receiving the measurement of the KPI, update coefficients of a polynomial function. The apparatus is operative to, based on the updated coefficients of the polynomial function, compute the plurality of expected measurements for the KPI, over a time-horizon. The apparatus is operative to compute a confidence band for each of the plurality of expected measurements for the KPI, using accuracy measurements obtained from past predictions. The apparatus is operative to report the plurality of expected measurements and corresponding confidence bands for the KPI to a management system.

There is provided a non-transitory computer readable media having stored thereon instructions for reporting an anomaly in a telecommunications node, the instructions comprising any of the steps described herein.

There is also provided a non-transitory computer readable media having stored thereon instructions for forecasting a plurality of expected measurements for a key performance indicator (KPI) in a telecommunications node, the instructions comprising any of the steps described herein.

The method, apparatus and non-transitory computer readable media provided herein present improvements to the way reporting anomalies and forecasting of expected measurements for a key performance indicator (KPI) operate.

### BRIEF DESCRIPTION OF THE DRAWINGS

FIG. 1 is a graph illustrating results obtained with different methods.

FIG. 2 is a schematic illustration of an anomaly detection process.

FIG. 3 is a graph illustrating anomaly detection results of an offline polynomial approach without re-training.

FIGS. 4 and 5 are graphs illustrating anomaly detection results of an offline polynomial approach with retraining on a scheduled weekly basis (parts 1 and 2).

FIG. 6 is a graph illustrating anomaly detection results according to the methods described herein.

FIG. 7 is a flowchart of a method for reporting an anomaly in a telecommunications node.

FIG. 8 is a flowchart of a method for forecasting a plurality of expected measurements for a key performance indicator (KPI) in a telecommunications node.

FIG. 9 is a schematic illustration of a virtualization environment in which the different methods, apparatuses and non-transitory computer readable media described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

It should be noted that examples provided herein based on Python code and that some formulas, derived from the examples, may use Python like notations.

In telecommunication network management, anomaly-detection is the process of continuous monitoring of KPIs of the network for detecting unusual/abnormal events. An abnormal event acts as an alert that the network under observation is not functioning properly. Network operators use an anomaly dashboard to keep a close watch on the health of their network, investigate and resolve issues flagged by anomaly alerts.

Anomalies are also usually stored in a database, for offline analysis. For example, a network operator can retrieve last week's anomalies and analyze them for recurring issues that need attention.

For example, anomaly detection can be used for monitoring frame-delay on a communication link. A sudden increase in frame-delay, from a few milliseconds to 100s of milliseconds may be an indication that the link is experiencing issues (hardware malfunction, over-utilization, etc.), thus impacting the user-traffic traversing that link. In this example, upon receiving a frame-delay anomaly alert, the network operator can check hardware sanity and/or traffic volume on the link. The operator can then take appropriate corrective actions.

Examples of telecom network KPIs include frame-delay, errored frames, packet loss, total packets in, total packets out, link latency, interface availability, memory utilization, disk utilization, central processing unit (CPU) utilization, number of http calls, etc.

Anomaly-detection can be used in multiple contexts. Anomaly detection is applicable to intrusion detection, fraud detection, fault detection, system health monitoring, event detection in sensor networks, etc.

As stated previously, existing models do not fully address the complexities of deploying and maintaining a productized anomaly-detection solution, including complexities such as memory footprint, processing speed, and handling of data-drift. Data-drift refers to changes in the nature or structure of the data over time. Data-drift is common in telecommunications networks management space, due, for example, to changes in the nature of the traffic and/or changes in the characteristics of network devices. A model that does not automatically handle data-drift requires periodic offline retraining and re-deployment, hence inducing complex model lifecycle-management (LCM) procedures.

Offline periodic retraining and re-deployment are challenging and make model LCM very complex. The procedure requires:
continuous monitoring of the performance of the deployed model, via some metrics published by the model itself;
gathering of historical data for next re-training cycle, resulting in additional data storage and/or data transfer;
scheduling and executing regular lengthy retraining/redeployment activities, including data-science, testing and validation in customer lab, and reserving maintenance windows on customer's servers for model-upgrade.

To monitor a KPI, there is a need to detect any time when there is a change in the normal behaviour of the KPI. Reasons there would be a change may include: network related reasons, a capturing device failed to record the measurement, or any other reason as explained previously. A time series is the value of metrics, or KPIs, captured sequentially over time. In all the drawings, the time series are univariant, with the X axis being the time and the value of each KPI or each metric individually as the Y axis.

One goal of monitoring KPIs is to provide alarms or messages indicating that a change in the normal behaviour of a KPI is detected.

In order to be able to evaluate the performance of the methods described herein, some baseline methods for anomaly detection are used, including the statistical analysis of a KPI over time, with e.g. a moving window, or a sequence of data. In this base line method, the mean and standard deviation of the KPI is calculated either for an entire window e.g. of one day, or for sub-windows, which can then be used as a comparison basis for future data. When a significant change is encountered, e.g. the difference with the mean expected value is above a threshold, or if the measurement is outside a number of standard deviations from the mean expected value (or according to another criteria), an anomaly can be reported. Such a solution is highly dependent on the number and/or size of the window(s).

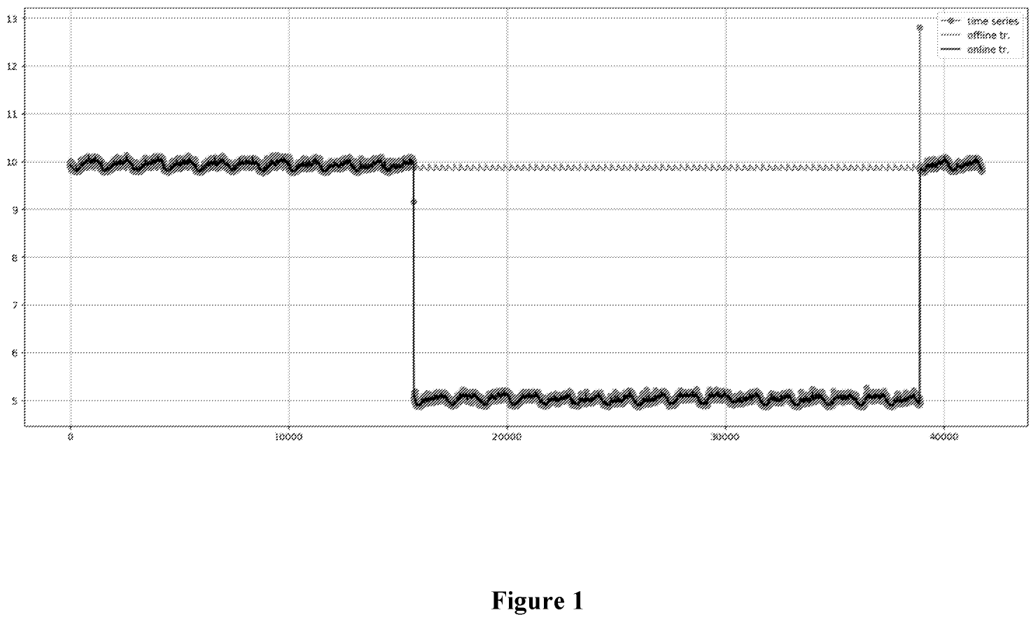

Another method that is used to establish the base line, consists in fitting a function that can replicate or model the behaviour of the KPI as the normal behaviour throughout the time series. In this case, some of the data is used for training, e.g. data gathered during a period of 10 days. The behaviour of the time series is modeled over this 10-day period and a function is fitted in the data. A polynomial function can be used to do so. This offline machine learning technique is used to learn the coefficients of the polynomial function over the 10-day period. In the present case, a level 7 polynomial function is used, because variations in the data are not high, but other levels could be used depending on the normal variations in the time series. In the examples provided herein and illustrated, the variations (sinusoid in shape) are not very high and a level 7 polynomial function works well (see FIGS. 1 and 3-6). The weights or coefficient of the polynomial function are then used to model the data for the next days.

Once the training is done, the model is ready to detect anomalies in the system. One model is used for each KPI that is being monitored.

The models described above are used as the baseline for later comparison with the methods provided herein. Offline training is illustrated in FIG. 1, as the curve that is around level 10 on the Y axis and remains at this level for the entire training samples (from 0 to more than 40000 on the X axis). FIG. 1 clearly illustrates when an anomaly happens (the drop from level 10 to 5 on the Y axis).

The baseline model described previously cannot adapt to such a change. When looking at FIG. 1, one sees that the normal behaviour resumes (at a different level) after the drop, until there is a rise again at a later time. Solutions to this type of change, with the baseline methods, would be retraining and updating the model, otherwise many false positives would be generated.

Building on the baseline methods, an improved training method is proposed that enables the model to adapt when changes happen in the time series. The training method is an online training method in which a small number of samples are used for initial training of the weights of the model (herein, weights are alternatively called coefficients or parameters), and with continuous training as new data is received. Thereby the model can adapt itself to the most recent changes in the time series.

The method described herein is a method that is much simpler than previously existing techniques that were developed in the last decade to deal with anomaly detection.

The model is then used to generate a prediction, to compare the prediction with actual data and to detect any discrepancies. The model used is similar to the baseline model, i.e. it is a 7^{th} order polynomial function (but it could be of a different order as well).

The method therefore consists of an on-line learning solution, with application to anomaly-detection. The online solution can automatically handle data-drift in that are frequent in telecommunications networks time-series. The solution integrates nicely with analytics data pipelines. The solution was tested on a large real-world customer data set, with very good results. The solution eliminates the need for anomaly detection (AD) model retraining and re-deployment, hence greatly simplifying model life-cycle management (LCM).

The methods provided herein allow designing a generic, adaptive and light-weight AD solution that can be easily integrated into a network management product. To that end, the online learning algorithm continuously updates the coefficients or parameters of the AD model to offset time-series drift and simplify the LCM of the model. This online learning algorithm can be integrated into a network management real-time analytics pipeline to accurately detect and report anomalies

The general problem statement of unsupervised AD consists in the following problem: provided a time series (Tᵢ), which can be seen as a series of points (xᵢ, yᵢ), i=1, . . . , N, where x is the time and y is the actual measurement, detect in an automatic fashion (i.e. without the help of humans in any form, e.g. without a priori knowledge) the various anomalies present in that time series. Moreover, in this specific context, an extra layer of complexity is represented by the fact that the time series is presented one point at a time while the previous observations have been forgotten.

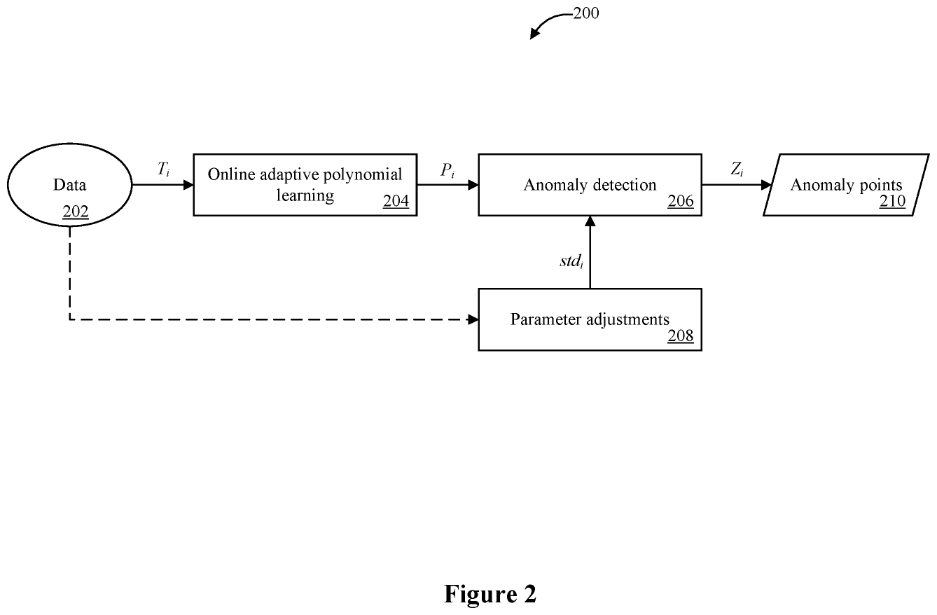

The overview of the proposed solution 200 is shown in FIG. 2. In FIG. 2, the data 202, in the form of a time series Tᵢ is the input of the online adaptive polynomial learning 204. As new data is obtained, parameter adjustments are calculated and used for anomaly detection 206, using the result of the online adaptive polynomial learning 204. Anomaly points 210 can then be reported.

As shown in FIG. 2, an adaptive solution based on online polynomial learning is designed for AD purpose, where polynomial curve Pᵢ is fitted to emulate the normal behavior (trend and seasonality) of the time series Tᵢ. Then, a confidence band is calculated inspired by z-score concept Zᵢ computed using stdᵢ, and every data point outside that confidence band is considered as an anomaly point.

The polynomial curve generated with this method can adapt itself to the latest changes or fluctuations in the time series in an online/incremental fashion. The model automatically adjusts its hyper-parameters upon receiving a new data point. Therefore, it does not require storage of state information or historical data. This approach can directly tackle the problem of AD without having to explore a full search-space of the polynomial hyper-parameters or coefficients: only the learning rate is pre-selected, to reflect the importance of new vs. historical observations. This approach also has a high-level accuracy, processing speed, and memory footprint that are comparable to the best standard methods.

Advantages include that the proposed online learning algorithm is a very light-weight solution and well-suited for real-time, large scale time-series AD in production environments. It is a fully automated approach (does not necessitate a human expert), it can adapt itself to upcoming observations, it reduces the number of false positives that are usually associated with data-drift, if stared with random polynomial coefficients, it converges to the best polynomial coefficients within few observations, it can also start from pre-trained polynomial coefficients, using available offline training data. Further, it does not consume extra memory to maintain the states or data history (previous observations), it is computationally efficient (fast processing of the data), and by eliminating the need for periodic retraining and re-deployment, it simplifies the model LCM.

The goal can be described as: given a time series Tᵢ of data points (xᵢ, yᵢ), with i=1, . . . , N, adapt the coefficients a=(a₀, a₁, . . . , a₇) of a 7-th order polynomial function P(x), which is the model, to follow the series every time a new observation is provided. The polynomial function is defined as:

P(x):=a₇x₇+a₆x₆+ . . . +a₂x₂+a₁x+a₀ (1)

A 7^{th} order polynomial function is used, which includes 7+1 coefficients a, which, in the context of the experiments that have been done, gives meaningful predictions. Polynomial functions of different orders could be used in other contexts.

A loss function, L to norm, that gives a difference between the observation and the prediction, is defined as:

L(a,xᵢ,yᵢ):=|P(a,xᵢ)−yᵢ|², for any given observation (xᵢ,yi) (2)

Note that analytical computation of the gradient can be made with:

∇ₐⱼL(xᵢ)=2(xᵢ)^{j}|P(xᵢ)−yᵢ|, for j=0, . . . , 7 (3)

In the next step, the values for the coefficients a are computed. All the observations that are made depend on time, i.e. those are time-dependent measurements. In this context, time can be seen as a variable and there is another variable that gives a measurement each time an observation is made.

At the beginning, few data points (observations) are available and these few datapoints are used to compute initial values for the coefficients. These coefficients should be better than, for example, using a stochastic approach, as they should have some meaning.

To find initial values for the coefficients a, M initial points (with M<N, e.g. a whole day of observations) are selected and a least square method is applied to find the coefficients of the polynomial function (the complexity being O(M·7²)=O(49·M)), using:

a=np.polyfit(X[0:M],y[0.M],degree), where degree=7 (4)

Polyfit is a polynomial fitting function which is fitted over the first few points that are initially available.

In the next step, the coefficients a that were initially computed are used. From this point on, the method uses only one new measurement at a time to update the polynomial function and these measurements are not stored, they are discarded. This allows the method to run in memory limited devices. One challenge is to use only one data at a time while ensuring that the polynomial function continues to provide good predictions and even improves the prediction over time. To do so, the polynomial function should adapt in time, e.g. it should be able to adapt to jumps in value that can occur occasionally (as illustrated and previously described in relation with FIG. 1).

Using an incremental learning method for the polynomial function enables to adapt the coefficients as soon as changes are observed in the measurements.

To do so, as illustrated by the code below, a gradient is added to the coefficients. The computation of the gradient can be exact because the polynomial function allows it and is very efficient.

The below code/formula enables the evolution of the coefficients a. Every time a new observation (xᵢ, yᵢ) is presented, the coefficients a are evolved by applying a single iteration of gradient descent:
for j in range (0, degree+1):

a[j]=a[j]−lr*grad[j][i] #j-th component of the gradient evaluated in xᵢ (5)

It should be noted that the Python function “range” works like this: range(0, N) is the range of integer numbers going from 0 to N−1. Thus, the interval “range(0, degree+1)” goes from 0 to 7 (i.e. 8 coefficients for a 7-th order polynomial).

The gradient is computed using formula 3.

The coefficient “lr” is the learning rate of the method. This parameter ranges from 0 to 1 and defines the relevance of past observations (bigger learning rates mean recent observations are very influent on the calculation of the polynomial coefficients). In the many experimental time-series, it has been found that a generic learning rate of 0.1 yields good results, but other values can alternatively be used.

It was observed that this method performs better than other methods in the art (e.g. ARIMA, which comprises a class of models that ‘explains’ a given time series based on its own past values).

As stated previously, in the many experimental time-series, it has been found that polynomial degree=7 yields good results. However, the method allows for other polynomial degrees, if required or desired.

The above described process can be combined with an adaptive z-score approach. In that case, it has been empirically observed that it is better to compute the average and standard deviation of the given time series, again, in an incremental fashion. The code for this part of the approach reads:

```
y = time_series
dim = len(y)
std = np.zeros((dim, 1))
alpha = 1.0e−4 # learning rate for std
std[0] = 1.0e−7 # initial conditions − a very small number
avg = y[0]
for n in range(1, dim):
  avg = avg + (y[n] − avg) / (dim − n)
  std[n] = std[n−1] + alpha*(np.power((y[n]−avg), 2.0) − std[n−1])
for n in range(0, dim):
```

| | |
|---|---|
| std[n] = math.sqrt(std[n]) | (6) |

In the above code, dim is the number of observations provided, len is a Python function used to compute the length of a given array, zeros is a known Python function which returns an array filled with zeros, alpha is a coefficient ranging from 0 to 1.0 and power is a Python function to compute power of a number.

Referring again to FIG. 2:

Zᵢ(Tᵢ−avgᵢ)/stdᵢ

If Zᵢ>3*stdᵢ or Zᵢ<−3*stdᵢ

Then report anomaly (7)

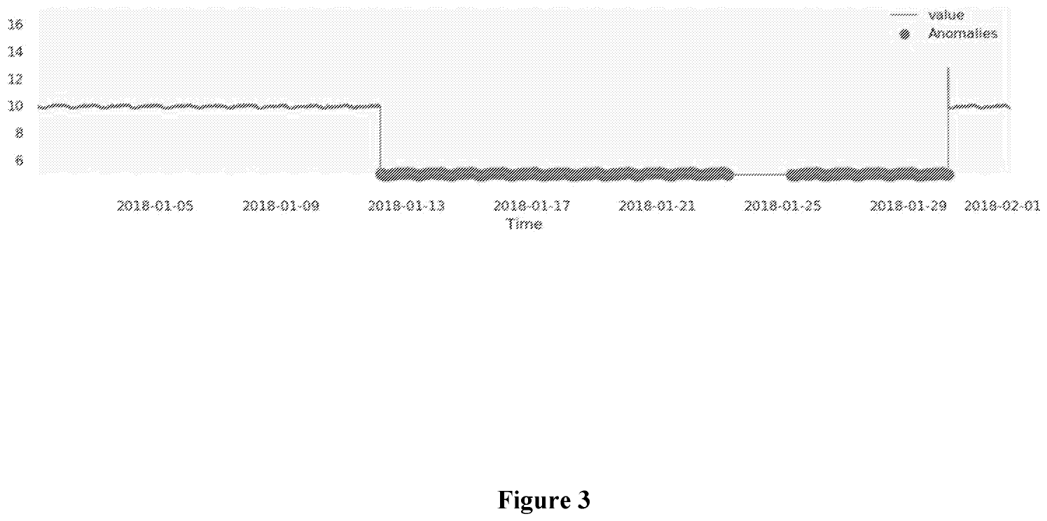

In the FIGS. 3-6, two different offline approaches (with/without retraining) are presented. The new online approach to detect anomalies (dots) is also presented using the same anonymized customer time series. The offline rolling polynomial approach (FIG. 3) generates continuous false positive anomalous points after a data drift happens (starting around 2018-01-13), because it was trained on the first week of data and was not able to adapt itself to the data-drift.

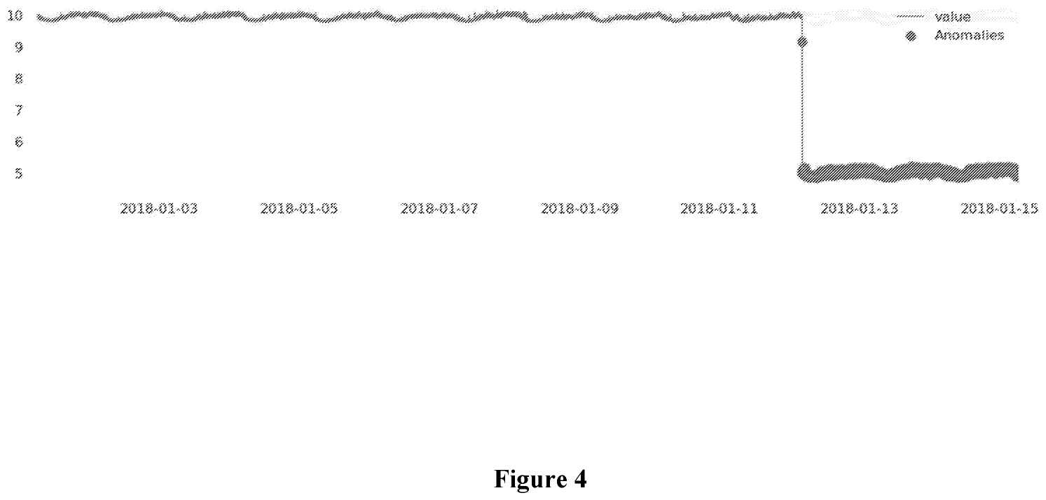

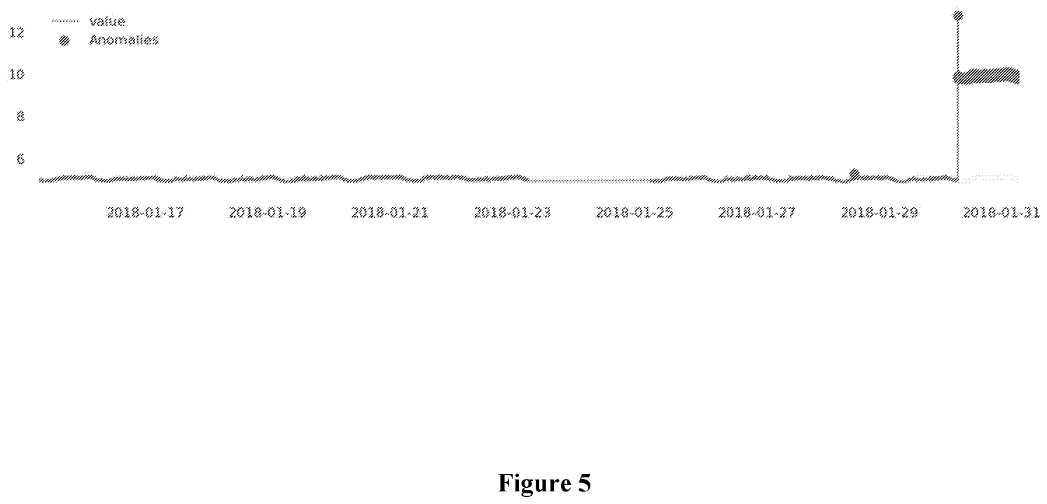

Offline retraining polynomial on a scheduled weekly basis (FIG. 4 and FIG. 5 which is the continuation of FIG. 4) slightly improves the performance, but it requires additional data gathering, retraining and re-deployment strategy which is very costly. With this method many false-positives can be observed upon a data-drift. The false positives disappear upon retraining.

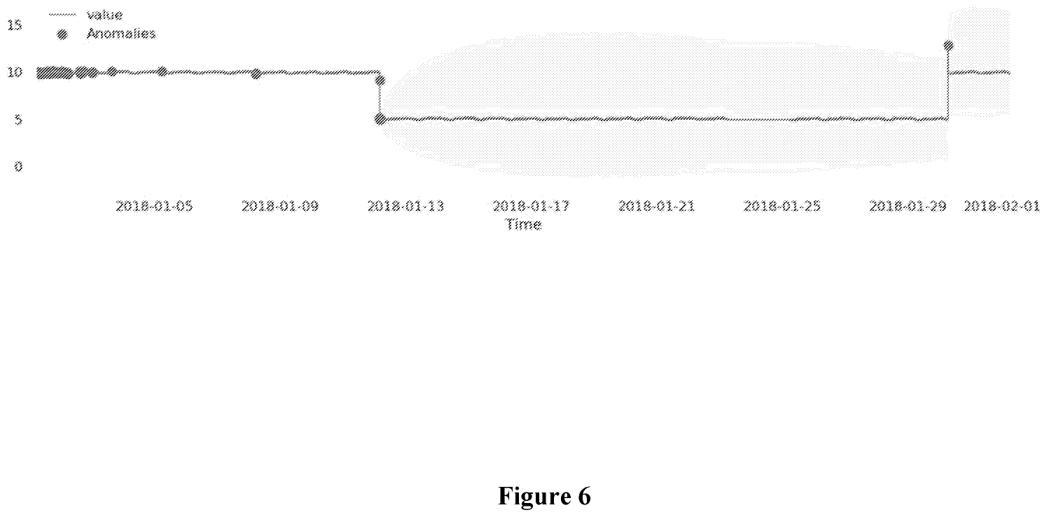

While it is clear that the online learning approach (FIG. 6) requires some initial time to converge to meaningful polynomial coefficients, once this process is achieved, it detects very meaningful anomalies (e.g. it does not get confused by an abrupt change in the data), and it eliminates false-positives related to data-drift. Consequently, the proposed online polynomial version can overcome the aforementioned LCM challenges and needs significantly less efforts/costs to maintain. It should be noted that the initial anomalies are due the model initial learning/convergence, and hence are ignored.

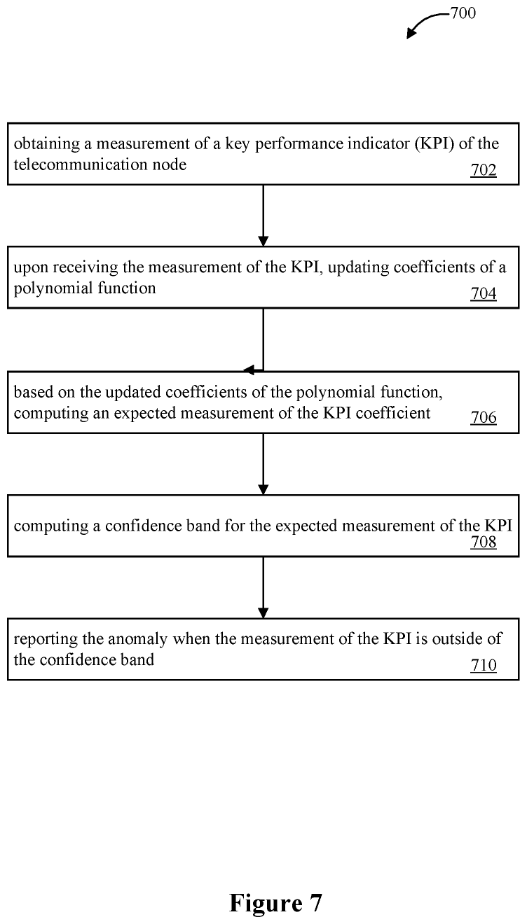

FIG. 7 is a flowchart of a method 700 for reporting an anomaly in a telecommunications node. The method comprises obtaining, step 702, a measurement of a key performance indicator (KPI) of the telecommunication node. The method comprises, upon receiving the measurement of the KPI, updating, step 704, coefficients of a polynomial function. The method comprises, based on the updated coefficients of the polynomial function, computing, step 706, an expected measurement of the KPI coefficient. The method comprises computing, step 708, a confidence band for the expected measurement of the KPI. The method comprises reporting, step 710, the anomaly when the measurement of the KPI is outside of the confidence band.

Initial coefficients of the polynomial function may be computed based on M initial measurements of the KPI and the coefficients a may be computed using: a polyfit(x[0:M], y[0:M], degree) where polyfit is a function that computes the coefficients using a least square method, x is the time at which is taken the measurement of the KPI, y is the measurement of the KPI and degree is the degree of the polynomial function.

Updating the coefficients of the polynomial function may comprise, for each of the coefficients of the polynomial function computing a loss function for the measurement of the KPI, computing a gradient of the loss function, and updating the coefficient as a function of the gradient of the loss function.

Computing the confidence band may comprise computing an average and a standard deviation for the expected measurement of the KPI based on previous measurements and setting the confidence band to minus three times the standard deviation from the average to plus three times the standard deviation from the average.

The confidence band may be computed for each measurement of the KPI in the time series and may include computing the average and the standard deviation.

Computing the average and the standard deviation may be based on a predetermined number of most recent previous measurements which does not include all the previous measurements.

The polynomial function may be a 7^{th} order polynomial function.

Computing the loss function for the measurement of the KPI may be done using: L(a, xᵢ, yᵢ)=|P(x)−yᵢ|² where L is the loss function, a is the coefficient of the polynomial function, yᵢ is the data point, P(a, xᵢ) is the expected measurement of the KPI and i is an index of the measurement of the KPI. Computing the gradient of the loss function may be done using: ∇ₐⱼL(xᵢ)=2 (xᵢ)|P(xᵢ)−yᵢ| where L is the loss function, xᵢ is the time at which is taken the measurement of the KPI, yᵢ is the measurement of the KPI, P(xᵢ) is the expected measurement of the KPI and i is an index of the measurement of the KPI.

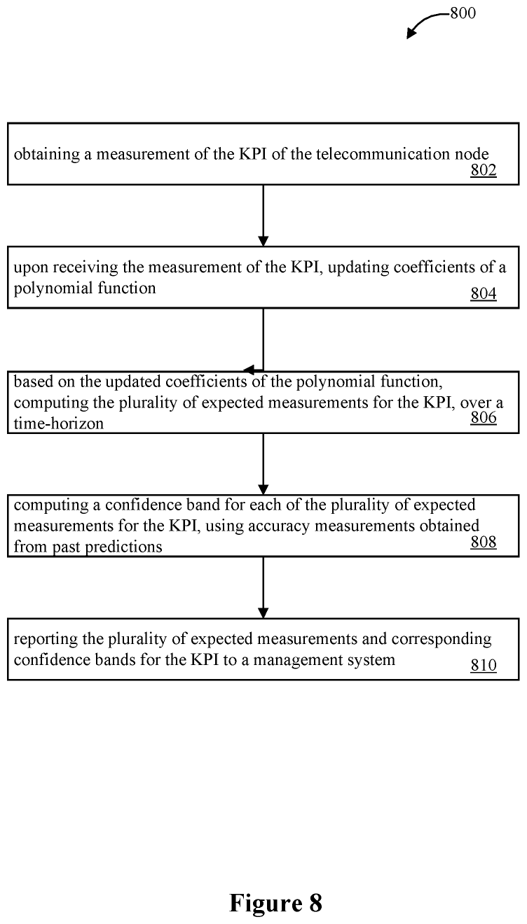

FIG. 8 is a flowchart of a method 800 for forecasting a plurality of expected measurements for a key performance indicator (KPI) in a telecommunications node. The method comprises obtaining, step 802, a measurement of the KPI of the telecommunication node. The method comprises upon receiving the measurement of the KPI, updating, step 804, coefficients of a polynomial function. The method comprises based on the updated coefficients of the polynomial function, computing, step 806, the plurality of expected measurements for the KPI, over a time-horizon. The method comprises computing, step 808, a confidence band for each of the plurality of expected measurements for the KPI, using accuracy measurements obtained from past predictions. The method comprises, reporting, step 810, the plurality of expected measurements and corresponding confidence bands for the KPI to a management system.

Initial coefficients of the polynomial function may be computed based on M initial measurements of the KPI and the coefficients a may be computed using: a polyfit(x[0:M], y[0:M], degree) where polyfit is a function that computes the coefficients using a least square method, x is the time at which is taken the measurement of the KPI, y is the measurement of the KPI and degree is the degree of the polynomial function.

Updating the coefficients of the polynomial function may comprise, for each of the coefficients of the polynomial function computing a loss function for the measurement of the KPI, computing a gradient of the loss function and updating the coefficient as a function of the gradient of the loss function.

Computing the confidence band may comprise computing an average and a standard deviation for the expected measurement of the KPI based on previous measurements and setting the confidence band to minus three times the standard deviation from the average to plus three times the standard deviation from the average.

The confidence band may be computed for each measurement of the KPI in the time series and includes computing the average and the standard deviation.

Computing the average and the standard deviation may be based on a predetermined number of most recent previous measurements which does not include all the previous measurements.

The polynomial function may be a 7^{th} order polynomial function.

Computing the loss function for the measurement of the KPI may be done using: L(a, xᵢ, yᵢ):=|P(xᵢ)−yᵢ|² where L is the loss function, a is the coefficient of the polynomial function, yᵢ is the data point, P(a, xᵢ) is the expected measurement of the KPI and i is an index of the measurement of the KPI.

Computing the gradient of the loss function may be done using: ∇ₐⱼL(xᵢ)=2 (xᵢ) |P(xᵢ)−yᵢ| where L is the loss function, xᵢ is the time at which is taken the measurement of the KPI, yᵢ is the measurement of the KPI, P(xᵢ) is the expected measurement of the KPI and i is an index of the measurement of the KPI.

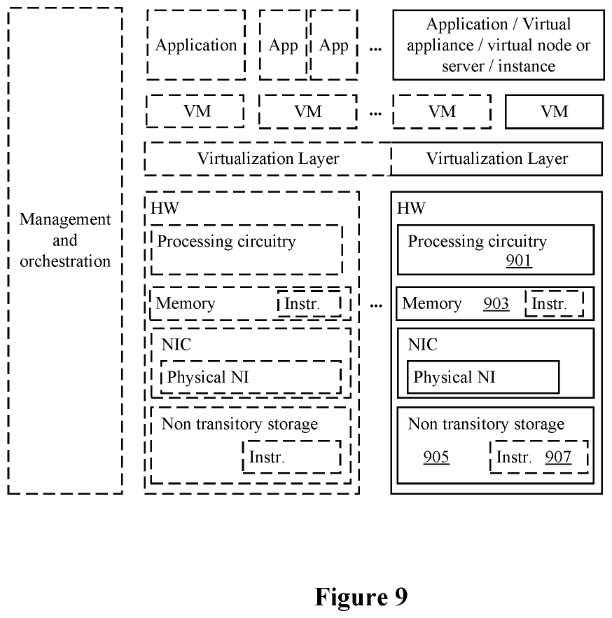

Referring to FIG. 9, there is provided a virtualization environment in which functions and steps described herein can be implemented.

A virtualization environment (which may go beyond what is illustrated in FIG. 9), may comprise systems, networks, servers, nodes, devices, etc., that are in communication with each other either through wire or wirelessly. Some or all of the functions and steps described herein may be implemented as one or more virtual components (e.g., via one or more applications, components, functions, virtual machines or containers, etc.) executing on one or more physical apparatus in one or more networks, systems, environment, etc.

A virtualization environment provides hardware comprising processing circuitry 901 and memory 903. The memory can contain instructions executable by the processing circuitry whereby functions and steps described herein may be executed to provide any of the relevant features and benefits disclosed herein.

The hardware may also include non-transitory, persistent, machine readable storage media 905 having stored therein software and/or instruction 907 executable by processing circuitry to execute functions and steps described herein.

Referring to FIG. 9, the apparatus (HW label in FIG. 9) is operative to report an anomaly in a telecommunications node. The apparatus comprises processing circuits 901 and a memory 903, the memory 903 containing instructions executable by the processing circuits 901 whereby the apparatus is operative to obtain a measurement of a key performance indicator (KPI) of the telecommunication node. The apparatus is operative to, upon receiving the measurement of the KPI, update coefficients of a polynomial function. The apparatus is operative to, based on the updated coefficients of the polynomial function, compute an expected measurement of the KPI coefficient. The apparatus is operative to compute a confidence band for the expected measurement of the KPI. The apparatus is operative to report the anomaly when the measurement of the KPI is outside of the confidence band.

Still referring to FIG. 9, the apparatus (HW label in FIG. 9) is operative to forecast a plurality of expected measurements for a key performance indicator (KPI) in a telecommunications node. The apparatus comprises processing circuits 901 and a memory 903, the memory 903 containing instructions executable by the processing circuits 901 whereby the apparatus is operative to obtain a measurement of the KPI of the telecommunication node. The apparatus is operative to, upon receiving the measurement of the KPI, update coefficients of a polynomial function. The apparatus is operative to, based on the updated coefficients of the polynomial function, compute the plurality of expected measurements for the KPI, over a time-horizon. The apparatus is operative to compute a confidence band for each of the plurality of expected measurements for the KPI, using accuracy measurements obtained from past predictions. The apparatus is operative to report the plurality of expected measurements and corresponding confidence bands for the KPI to a management system. Both apparatuses are further operative to execute any of the steps described herein.

Referring to FIG. 9, the non-transitory computer readable media 905 has stored thereon instructions for reporting an anomaly in a telecommunications node, the instructions comprising any of the steps described herein.

Referring to FIG. 9, the non-transitory computer readable media 905 has stored thereon instructions for forecasting a plurality of expected measurements for a key performance indicator (KPI) in a telecommunications node, the instructions comprising any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method for reporting an anomaly in a telecommunications node, comprising:
obtaining a measurement of a key performance indicator (KPI) of the telecommunication node;
upon receiving the measurement of the KPI, updating coefficients of a polynomial function;
based on the updated coefficients of the polynomial function, computing an expected measurement of the KPI coefficient;
computing a confidence band for the expected measurement of the KPI; and
reporting the anomaly when the measurement of the KPI is outside of the confidence band.

2. The method of claim 1, wherein initial coefficients of the polynomial function are computed based on M initial measurements of the KPI and the coefficients a are computed using: a=polyfit(x[0:M], y[0:M], degree)
where polyfit is a function that computes the coefficients using a least square method, x is the time at which is taken the measurement of the KPI, y is the measurement of the KPI and degree is the degree of the polynomial function.

3. The method of claim 1, wherein updating the coefficients of the polynomial function comprises, for each of the coefficients of the polynomial function:
computing a loss function for the measurement of the KPI;
computing a gradient of the loss function; and
updating the coefficient as a function of the gradient of the loss function.

4. The method of claim 1, wherein computing the confidence band comprises:
computing an average and a standard deviation for the expected measurement of the KPI based on previous measurements; and
setting the confidence band to minus three times the standard deviation from the average to plus three times the standard deviation from the average.

5. The method of claim 4, wherein the confidence band is computed for each measurement of the KPI in the time series and includes computing the average and the standard deviation.

6. The method of claim 4, wherein computing the average and the standard deviation is based on a predetermined number of most recent previous measurements which does not include all the previous measurements.

7. The method of claim 1, wherein the polynomial function is a 7^{th} order polynomial function.

8. The method of claim 3, wherein computing the loss function for the measurement of the KPI is done using: L(a, xᵢ, yᵢ)=|P(xᵢ)−yᵢ|²
where L is the loss function, a is the coefficient of the polynomial function, yᵢ is the data point, P(a, xᵢ) is the expected measurement of the KPI and i is an index of the measurement of the KPI.

9. The method of claim 3, wherein computing the gradient of the loss function is done using: ∇ₐⱼL(xᵢ)=2 (xᵢ) |P(xᵢ)−yᵢ|

where L is the loss function, xᵢ is the time at which is taken the measurement of the KPI, yᵢ is the measurement of the KPI, P(x) is the expected measurement of the KPI and i is an index of the measurement of the KPI.

10. A method for forecasting a plurality of expected measurements for a key performance indicator (KPI) in a telecommunications node, comprising:
obtaining a measurement of the KPI of the telecommunication node;
upon receiving the measurement of the KPI, updating coefficients of a polynomial function;
based on the updated coefficients of the polynomial function, computing the plurality of expected measurements for the KPI, over a time-horizon;
computing a confidence band for each of the plurality of expected measurements for the KPI, using accuracy measurements obtained from past predictions; and
reporting the plurality of expected measurements and corresponding confidence bands for the KPI to a management system.

11. The method of claim 10, wherein initial coefficients of the polynomial function are computed based on M initial measurements of the KPI and the coefficients a are computed using: a=polyfit(x[0:M], y[0:M], degree)
where polyfit is a function that computes the coefficients using a least square method, x is the time at which is taken the measurement of the KPI, y is the measurement of the KPI and degree is the degree of the polynomial function.

12. The method of claim 10, wherein updating the coefficients of the polynomial function comprises, for each of the coefficients of the polynomial function:
computing a loss function for the measurement of the KPI;
computing a gradient of the loss function; and
updating the coefficient as a function of the gradient of the loss function.

13. The method of claim 10, wherein computing the confidence band comprises:
computing an average and a standard deviation for the expected measurement of the KPI based on previous measurements; and
setting the confidence band to minus three times the standard deviation from the average to plus three times the standard deviation from the average.

14. The method of claim 13, wherein the confidence band is computed for each measurement of the KPI in the time series and includes computing the average and the standard deviation.

15. The method of claim 13, wherein computing the average and the standard deviation is based on a predetermined number of most recent previous measurements which does not include all the previous measurements.

16. The method of claim 10, wherein the polynomial function is a 7^{th} order polynomial function.

17. The method of claim 12, wherein computing the loss function for the measurement of the KPI is done using: L(a, xᵢ, yᵢ):=|P(xᵢ)−yᵢ|²
where L is the loss function, a is the coefficient of the polynomial function, yᵢ is the data point, P(a, xᵢ) is the expected measurement of the KPI and i is an index of the measurement of the KPI.

18. The method of claim 12, wherein computing the gradient of the loss function is done using: ∇ₐⱼL(xᵢ)=2 (xᵢ) |P(xᵢ)−yᵢ|

where L is the loss function, xᵢ is the time at which is taken the measurement of the KPI, yᵢ is the measurement of the KPI, P(x) is the expected measurement of the KPI and i is an index of the measurement of the KPI.

19. An apparatus operative to report an anomaly in a telecommunications node comprising processing circuits and a memory, the memory containing instructions executable by the processing circuits whereby the apparatus is operative to:
obtain a measurement of a key performance indicator (KPI) of the telecommunication node;
upon receiving the measurement of the KPI, update coefficients of a polynomial function;
based on the updated coefficients of the polynomial function, compute an expected measurement of the KPI coefficient;
compute a confidence band for the expected measurement of the KPI; and
report the anomaly when the measurement of the KPI is outside of the confidence band.

20. An apparatus operative to forecast a plurality of expected measurements for a key performance indicator (KPI) in a telecommunications node comprising processing circuits and a memory, the memory containing instructions executable by the processing circuits whereby the apparatus is operative to:
obtain a measurement of the KPI of the telecommunication node;
upon receiving the measurement of the KPI, update coefficients of a polynomial function;
based on the updated coefficients of the polynomial function, compute the plurality of expected measurements for the KPI, over a time-horizon;
compute a confidence band for each of the plurality of expected measurements for the KPI, using accuracy measurements obtained from past predictions; and
report the plurality of expected measurements and corresponding confidence bands for the KPI to a management system.

21-30. (canceled)
